(19) United States
(12) Patent Application Publication
(10) Pub. No.: US 2004/0182833 A1
(43) Pub. Date: Sep. 23, 2004

(54) Method for manufacturing a substrate with a pre-seasoned plasma processing system

(75) Inventor: Steven T. Fink, Mesa, AZ (US)

Correspondence Address: PILLSBURY WINTHROP, LLP, P.O. BOX 10500, MCLEAN, VA, 22102, US

(73) Assignee: Tokyo Electron Limited, Tokyo (JP)

(21) Appl. No.: 10/766,474

(22) Filed: Jan. 29, 2004

Related U.S. Application Data
(60) Provisional application No. 60/443,887, filed on Jan. 31, 2003.

(51) Int. Cl. B23K 10/00

(52) U.S. Cl. 219/121.43

(57) ABSTRACT

A method for manufacturing a substrate with a plasma processing system having preconditioned components. The method comprises obtaining a component of a plasma processing system that has been coated with a film of material, disposing the component in a plasma processing chamber, disposing a substrate on a chuck in the plasma processing chamber, and forming a plasma in a processing region within the plasma processing chamber.

This non-provisional application claims the benefit of U.S. Provisional Application No. 60/443,887, filed on Jan. 31, 2003, the content of which is incorporated in its entirety by reference.

This application is also related to U.S. application Ser. No. 10/291,533, filed Nov. 12, 2002, the content of which is incorporated herein in its entirety by reference.

### BACKGROUND OF THE INVENTION

1. Field of the Invention

This invention relates to a system and method for manufacturing a substrate with a plasma processing system, and more particularly to a system and method for manufacturing a substrate wherein different parts of the plasma processing system have been preconditioned.

2. Description of Related Art

Plasma processing systems are used in the manufacture and processing of semiconductors, integrated circuits, displays and other devices or materials, to remove material from or to deposit material on a substrate, such as a semiconductor substrate. In plasma processing systems, one factor affecting the processing chemistry and the degree of processing is the presence of contaminant particles on the different parts of the plasma processing system.

Generally, to prevent contamination of the processing chemistry and to normalize processes across processing cycles, the process chamber can be seasoned in situ at the beginning of the processing cycles. Seasoning is commonly referred to as the process of building inside the chamber a coating of materials on the internal parts of that chamber prior to any processing of the substrates. Typically, processing up to twenty-five dummy substrates may be required to season the process chamber. During this seasoning time, the plasma processing system is inoperative until the thin seasoning film is generated in the process chamber.

### SUMMARY OF THE INVENTION

The present invention relates to a method for manufacturing a substrate with a plasma processing system having a preconditioned component. The method comprises obtaining a component of a plasma processing system that has been coated with a film of material, disposing the component in a plasma processing chamber, disposing a substrate on a chuck in the plasma processing chamber, and forming a plasma in a processing region within the plasma processing chamber.

### BRIEF DESCRIPTION OF THE DRAWINGS

FIG. 1 is a schematic representation of a plasma processing system according to an embodiment of the present invention;

FIG. 2 is a schematic representation of a plasma processing system showing a plasma baffle assembly according to an embodiment of the present invention;

FIG. 3 is a schematic representation of a plasma processing system showing a grounded top electrode plasma device according to an embodiment of the present invention; and

FIG. 4 is a schematic representation of a plasma processing system showing an Electro-Static Radio Frequency type source according to an embodiment of the present invention.

### DETAILED DESCRIPTION OF THE EMBODIMENTS OF THE INVENTION

In the following description, in order to facilitate a thorough understanding of the invention and for purposes of explanation and not limitation, specific details are set forth, such as a particular geometry of the process chamber, the baffle assembly and the ring member, and the plasma generating techniques, etc. However, the invention may be practiced in other embodiments that depart from these specific details. The term plasma is used to refer to a mixture of electrons, negative and positive ions, as well as neutral species, such as atoms, molecules and radicals.

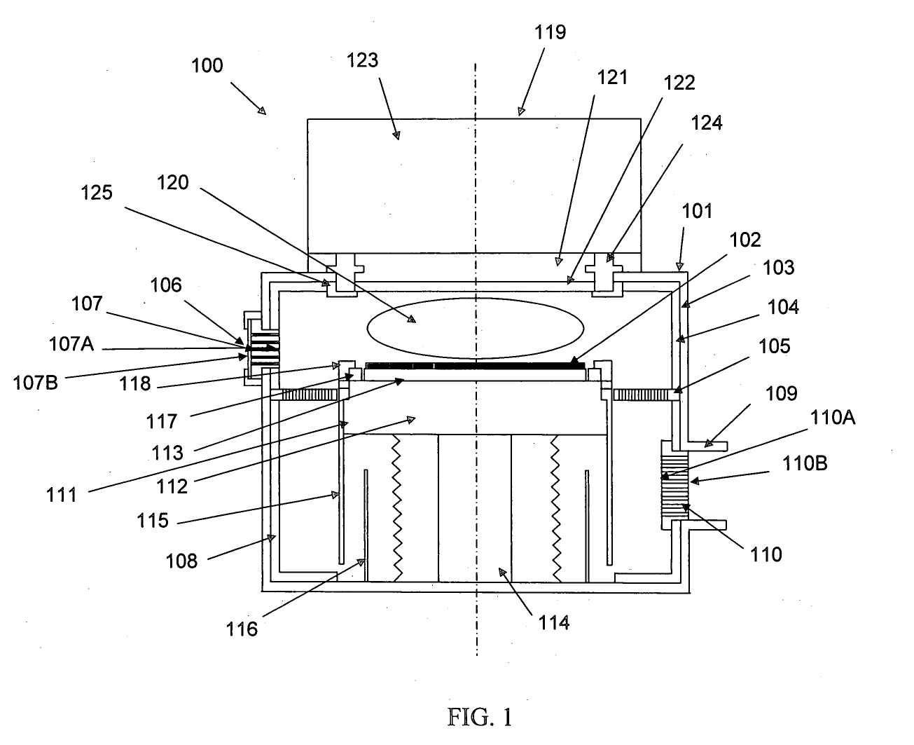

FIG. 1 is a schematic representation of a plasma processing system 100 according to one embodiment of the present invention. In the following description, selected elements of the plasma processing system 100 will be described. However, it should be understood that other conventional elements can also be present.

Plasma processing system 100 comprises a chamber 101 that functions as a vacuum processing chamber adapted to perform plasma etching from and/or material deposition on a substrate 102. Substrate 102 may be, for example, a semiconductor substrate, such as silicon, that is exposed to plasma 120 during a plasma process. Chamber 101 includes inner wall 103 on which upper liner 104 and lower liner 108 are mounted. Upper liner 104 and lower liner 108 can be removed from inner wall 103 during maintenance operations and may be preconditioned before being mounted on inner wall 103. During this preconditioning treatment, which is performed in a separate plasma processing chamber (not shown in FIG. 1), a film of material is coated on upper liner 104 and lower liner 108. This film of material may comprise a material substantially similar to the substrate material that is exposed to plasma 120 during a plasma process. Typically, during an etch process, this substrate material may consist of the layers that will be etched with or exposed to the chemistry of plasma 120. Therefore, this film of material may comprise, for example, Fluoro Silicon Glass (FSG), silicon dioxide, titanium nitride, or aluminum. This film of material may also comprise some fluorocarbon materials coming from the process chemistry, other materials coming from the resist layer coated on the substrate material before the etch process. The film may have a thickness of from about 1 to about 500 microns.

In one embodiment of the invention, this preconditioning treatment may be performed in that separate plasma chamber (not shown in FIG. 1) by using dummy substrates, which comprise a substrate material similar to the substrate material of substrate 102. In this embodiment, upper liner 104 and lower liner 108 are coated indirectly with the substrate material of the dummy substrates, dissociated by the plasma of that separate chamber. Therefore, in this embodiment, that separate chamber may be similar to chamber 101. In another embodiment of the invention, the preconditioning treatment may be performed in a plasma processing chamber deposition. In this embodiment, upper liner 104 and lower liner 108 are directly coated with a desired film of material. During the preconditioning treatment, it is also possible to control the thickness and the uniformity of the film of material that is coated on upper liner 104 and lower liner 108.

In one embodiment of the invention the preconditioning treatment is performed either by the liner manufacturer, the plasma processing chamber manufacturer or more generally by any supplier in the business of selling preconditioned components. In such a case, the customer obtains the liner in a preconditioned form. The characteristics of the preconditioning, in terms of nature of the material, thickness and uniformity of the coating may then be specified by the customer to the supplier. In another embodiment of the invention, the characteristics of the preconditioning may be determined by the supplier, a process recipe, the chamber parameters, the pre-seasoning time or the type of process used to manufacture the substrate.

Plasma processing system 100 further comprises pump opening 109 arranged in inner wall 103 of chamber 101. As shown in FIG. 1, pump opening 109 connects chamber 101 to a process vacuum pump (not shown in FIG. 1). In the embodiment depicted in FIG. 1, plasma processing system 100 may also comprise a pumping deposition shield 110 that is arranged in pump opening 109. The pumping deposition shield 110 can, for example, confine the plasma to the processing space within chamber 101, and reduce the extent to which plasma infiltrates the pumping system. Pump deposition shield 110 can easily be removed during maintenance operations and may also be preconditioned, like upper liner 104 and lower liner 108, before being mounted in pump opening 109. As previously mentioned, this preconditioning treatment, which is performed in a separate process chamber, consists of coating a film of material on pumping deposition shield 110. Again, this film of material may comprise a material similar to the substrate material of substrate 102 that is exposed to plasma 120 during a plasma process. Typically, during an etch process, this substrate material may consist of the layers that will be etched with or exposed to the chemistry of plasma 120, such as the layers of Fluoro Silicon Glass (FSG), silicon dioxide, titanium nitride, or aluminum. In the embodiment depicted in FIG. 1, both sides 110A and 110B of pumping deposition shield 110 are preconditioned. However, it is also possible to carry out the object of the invention by preconditioning only side 110A, which is in contact with the interior volume defined by chamber 101.

Plasma processing system 100 also includes diagnostic opening 106 arranged in inner wall 103 of chamber 101. Diagnostic opening 106 is in communication with an optical diagnostic system (not shown in FIG. 1). The optical diagnostic optical system is constructed and arranged to monitor plasma processes by detecting a plasma process condition based on the optical transmission from plasma 120. As shown in FIG. 1, plasma processing system 100 may further comprise an optical window deposition shield 107 that is arranged in diagnostic opening 106. Optical window deposition shield 107 can easily be removed during maintenance operations and may be preconditioned, like upper liner 104, lower liner 108 and pumping deposition shield 110, before being mounted in diagnostic opening 106. This preconditioning treatment, which is performed in a separate process chamber, is similar to the one described previously and consists of coating a film of material on optical window deposition shield 107. In the embodiment depicted in FIG. 1, both sides 107A and 107B of optical window deposition shield 107 have been preconditioned. However, it is also possible to carry out the object of the invention by coating only side 107A, which is in contact with the interior volume defined by chamber 101.

Plasma processing system 100 also comprises a pumping baffle plate 105 disposed around chuck 111. As shown in FIG. 1, pumping baffle plate 105 extends radially from inner wall 103 of chamber 101 to the periphery of chuck 111, thereby separating pump opening 109 from the processing region defined by plasma 120. In the embodiment depicted in FIG. 1, the pumping baffle plate has an annular cylindrical form. However, other shapes can be used. Alternative embodiments include, for example, shapes having a polygonal form or an elliptical form. One function of pumping baffle plate 105 is to improve the confinement of plasma 120 in chamber 101. Another function of pumping baffle plate 105 is to keep plasma 120 from entering areas where harm could occur to mechanical components. In addition, another function of pumping baffle plate 105 is to regulate the flow of gases in chamber 101 and to adjust the flow of gases entering pump opening 109. In the embodiment shown in FIG. 1, pumping baffle plate 105 is perforated by a plurality of holes such that process gases of plasma 120 are exhausted through the holes to pump opening 109. Like upper liner 104, lower liner 108, pumping deposition shield 110 or optical window deposition shield 107, pumping baffle plate 105 can easily be removed during maintenance operations and may be preconditioned before being disposed in the chamber. This preconditioning treatment, which is performed in a separate chamber, is similar to the one described above and consists of coating a film of material on pumping baffle plate 105.

Plasma processing system 100 may further comprise a bellows shield 115 that is mounted at the periphery of chuck 111. Chuck 111 may be connected to a radio frequency (RF) power supply (not shown) to generate and/or attract ions in plasma 120. Chuck 111 comprises first plate 112 that supports substrate holder 113 on which substrate 102 is disposed. As shown in the embodiment depicted in FIG. 1, a moving assembly 114 supports and vertically moves chuck 111 in chamber 101. As also shown in FIG. 1, bellows shield 115 extends along moving assembly 114 and faces inner shield 116. Inner shield 116 is disposed on the bottom of chamber 101 and also extends along moving assembly 114. In this embodiment, bellows shield 115 is long enough so that bellows shield 115 and inner shield 116 always face each other regardless of the position of chuck 111 in chamber 101. Like upper liner 104, lower liner 107, pumping deposition shield 110, optical window deposition shield 107, or pumping baffle plate 105, bellows shield 115 and inner shield 116 can easily be removed during maintenance operations and may be preconditioned before being disposed at the periphery of chuck 111. This preconditioning treatment, which is performed in a separate chamber, is similar to the one described above and consists of coating a film of material on bellows shield 115.

Plasma processing system 100 further comprises a shield ring 117 and a focus ring 118 disposed at the periphery and on the top part of chuck 111. One function of shield ring 117 and focus ring 118 is to control a plasma process proximate to the periphery of substrate 102. Like upper liner 104, lower liner 107, pumping deposition shield 110, optical window deposition shield 107, pumping baffle plate 105, or bellows shield 115, shield ring 117 and focus ring 118 can easily be removed during maintenance operations and may be preconditioned before being disposed at the periphery of chuck 111. This preconditioning treatment, which is performed in a separate chamber, is similar to the one described above and consists of coating a film of material on shield ring 117 and focus ring 118.

Plasma processing system 100 also includes a plasma generating system 119, which comprises an electrode assembly 121. Electrode assembly 121 includes an upper electrode 122 arranged within chamber 101 and facing chuck 111. Upper electrode 122 may have a plurality of holes, e.g.. a shower head, for process gas injection (not shown in FIG. 1). Electrode assembly 121 may be electrically connected to a RF power supply system (not shown in FIG. 1). The RF power supply system may have coupled thereto an associated impedance match network assembly 123 to match the impedance of upper electrode 122 and associated plasma 120 to the source impedance of the RF power supply system, thereby increasing the power that may be delivered by the RF power supply to electrode assembly 121 and associated plasma 120. Like upper liner 104, lower liner 108, pumping deposition shield 110, optical window deposition shield 107, pumping baffle plate 105 or bellows shield 115, upper electrode 122 can easily be removed during maintenance operations and may be preconditioned before being disposed in chamber 101. This preconditioning treatment, which is performed in a separate chamber, is similar to the one described above and consists of coating a film of material on upper electrode 122.

Plasma processing system 100 further comprises an insulating member 124 and an upper shield ring 125. Insulating member 124 is arranged at the periphery of electrode assembly 121 and isolates chamber 101 from electrode assembly 121. Upper shield ring 125 is disposed at the periphery of upper electrode 122 and covers the part of insulating member 124 exposed to plasma 120 during a plasma process. Like upper liner 104, lower liner 108, pumping deposition shield 110, optical window deposition shield 107, pumping baffle plate 105, bellows shield 115 or upper electrode 122, insulating member 124 and upper shield ring 125 can easily be removed during maintenance operations and may be preconditioned before being disposed in chamber 101. This preconditioning treatment, which is performed in a separate chamber, is similar to the one described above and consists of coating a film of material on insulating member 124 and upper shield ring 125.

Other embodiments of the plasma processing system 100 will be described below. In the description of these other embodiments, only the points of difference of these embodiments from the previous embodiment will be described. That is, in the alternative embodiments shown in FIGS. 1-4, the constituent parts which are the same as those in the first embodiment are referenced correspondingly in the drawings and the description about them will be omitted.

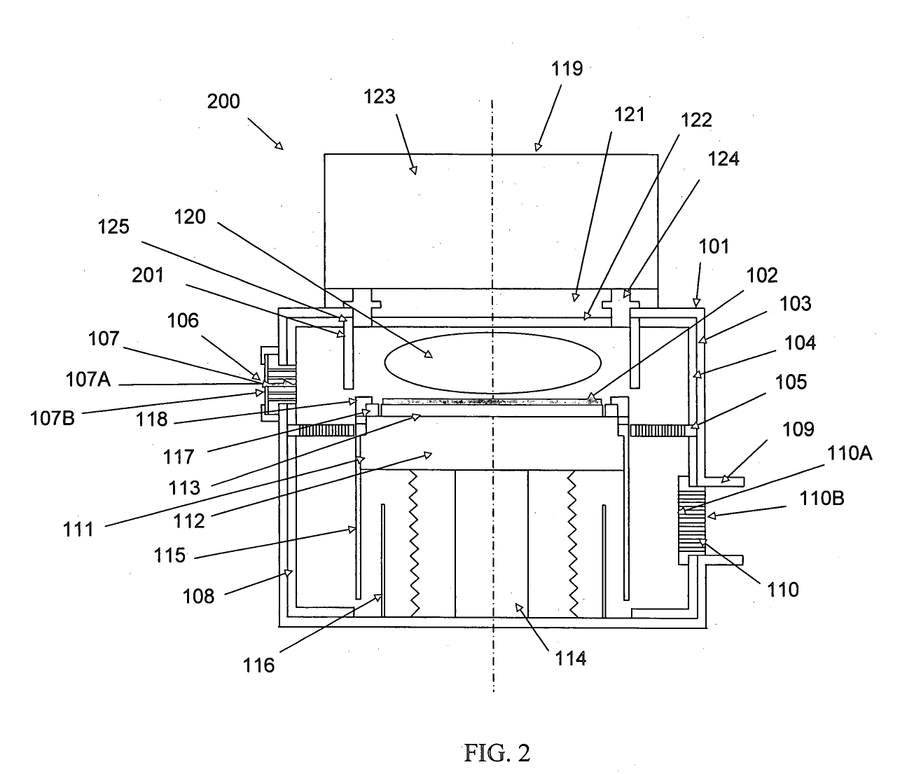

FIG. 2 is a schematic representation of a plasma processing system 200 according to an embodiment of the invention. In this embodiment, chamber 101 comprises a plasma baffle assembly 201, which surrounds the outside edges of chuck 111. As shown in FIG. 2, plasma baffle assembly 201 may be formed to conform for example to the lower portions of the electrode assembly 121 while extending down, cylindrically, to closely surround the plasma proximate to substrate 102. In one embodiment, plasma baffle assembly 201 encloses substrate holder 113 or chuck 111 during a plasma process and permits substrate 102 exchange when substrate holder 113 is lowered to a transfer position by translation of moving assembly 114. Therefore, plasma baffle assembly 201 is long enough to enclose chuck 111 and substrate holder 113 during a plasma process but not long enough to hamper substrate 102 exchange when the substrate holder 113 is in its lowest or transfer position.

Plasma baffle assembly 201 that extends between electrode assembly 121 and substrate holder 113 may be perforated by many high aspect ratio holes, not shown on this figure, of various diameters. These high aspect ratio holes substantially attenuate plasma 120 in an area bound by substrate 113, upper electrode 122 and baffle assembly 201. Gases are exhausted through the holes to the pumping system (not shown in FIG. 2). As shown in the embodiment depicted in FIG. 2, baffle assembly 201 has a cylindrical shape. However, other shapes may be used. Alternative embodiments include, for example, shapes such as a conical section, a polygonal section and spherical section.

Like some of the other elements depicted in FIG. 1, plasma baffle assembly 201 can easily be removed during maintenance operations and may be preconditioned before being mounted in chamber 101. This preconditioning treatment, which is performed in a separate chamber, is similar to the one described above and consists of coating a film of material on plasma baffle assembly 201.

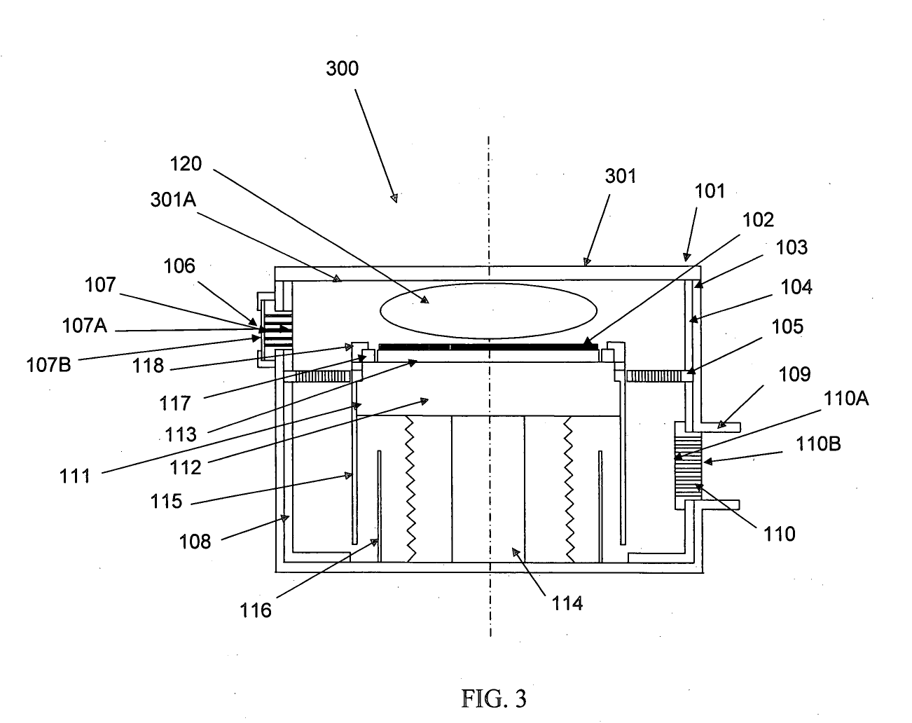

FIG. 3 is a schematic representation of a plasma processing system 300 according to an embodiment of the invention. Plasma processing system 300 comprises a grounded top electrode plasma device 301, having a surface 301A facing substrate holder 113. In this embodiment, substrate holder 113 is connected to a power source supply (not shown in FIG. 3) and acts as an electrode. Like some of the other elements depicted in FIG. 1 or 2, grounded top electrode plasma device 301 can easily be removed during maintenance operations and may be preconditioned before being mounted in chamber 101. This preconditioning treatment, which is performed in a separate chamber, is similar to the one described above and consists of coating a film of material on surface 301A of grounded top electrode plasma device 301.

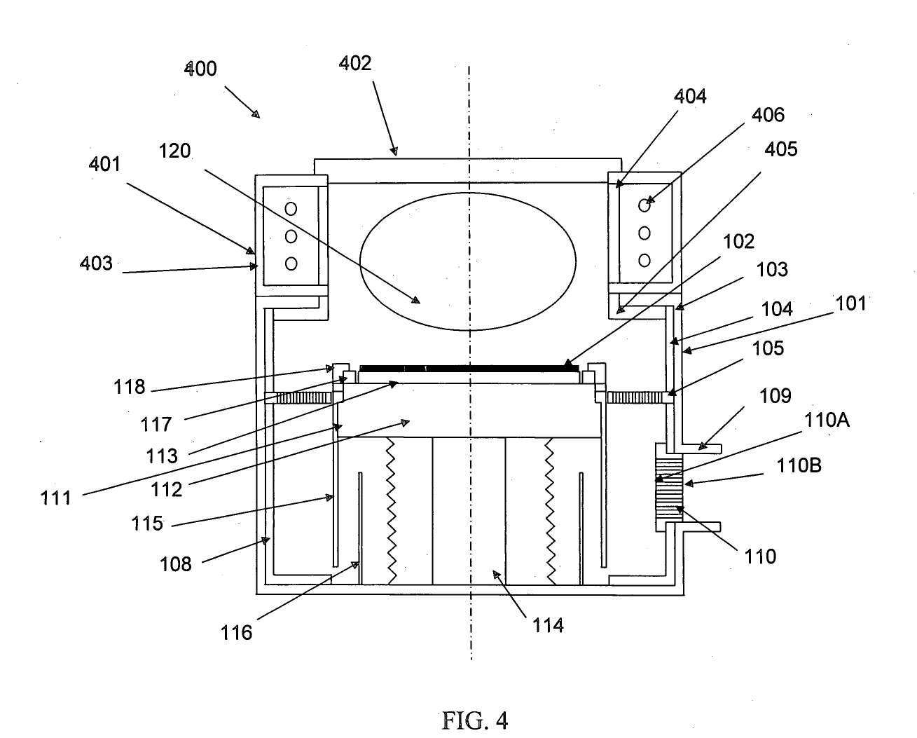

FIG. 4 is a schematic representation of a plasma processing system 400 according to an embodiment of the invention. In the embodiment depicted in FIG. 4, plasma 120 is generated by an inductively coupled plasma source 401 mounted on the top surface of chamber 101. Inductively coupled plasma source 401 comprises an inject plate assembly 402 for injecting process gas in chamber 101. Inductively coupled plasma source 401 also comprises a process tube 403 having sidewall 404 and bottom surface 405. Process tube 403 houses inductive coil 406 that surrounds chamber 101 to create a radio frequency magnetic field within chamber 101 which inductively produces plasma 120.

In the embodiment depicted in FIG. 4, the parts of inductively coupled plasma source 401 that are in contact with the interior volume defined by chamber 101 may be preconditioned. These parts may include for example inject plate 402, sidewall 404 and bottom surface 405. As mentioned previously, this preconditioning treatment, which is performed in a separate chamber, is similar to the one described above and consists of coating a film of material on the surface of these parts that is in contact with the interior volume defined by chamber 101.

While a detailed description of presently preferred embodiments of the invention have been given above, various alternatives, modifications, and equivalents will be apparent to those skilled in the art without varying from the spirit of the invention. For example, it should be apparent to one of ordinary skill in the art that other parts comprised in the plasma processing systems depicted in FIGS. 1-4 may be preconditioned. Specifically, all the parts that are in contact with the interior volume defined by the chamber 101 may also be preconditioned. Therefore, the above description should not be taken as limiting the scope of the invention, which is defined by the appended claims.

What is claimed is:

1. A method for manufacturing a substrate with a plasma processing system, the method comprising:
obtaining a component of a plasma processing system which has been coated with a film of material;
disposing said component in a plasma processing chamber, said component having been coated outside of said plasma processing chamber;
disposing a substrate on a chuck in the plasma processing chamber; and
forming a plasma in a processing region within the plasma processing chamber.

2. The method for manufacturing a substrate with a plasma processing system as recited in claim 1, wherein the obtaining includes obtaining a component from one of a component manufacturer and plasma processing chamber manufacturer.

3. The method for manufacturing a substrate with a plasma processing system as recited in claim 1, wherein:
the substrate comprises a substrate material that is exposed to the plasma during a plasma process; and
the film of material coated on the component comprises a material that is substantially similar to the substrate material.

4. The method for manufacturing a substrate with a plasma processing system as recited in claim 1, wherein the film of material has been coated with a second plasma processing chamber different from said plasma processing chamber.

5. The method for manufacturing a substrate with a plasma processing system as recited in claim 4, wherein the plasma processing chamber used to coat the component is similar to the plasma processing chamber where the substrate is disposed.

6. The method for manufacturing a substrate with a plasma processing system as recited in claim 1, wherein the film of material comprises a minimum thickness determined by at least one of a customer specification, a supplier specification, a process recipe, a chamber parameter, a pre-seasoning time and a type of process used to manufacture the substrate.

7. The method for manufacturing a substrate with a plasma processing system as recited in claim 1, wherein the film of material comprises a uniformity determined by at least one of a customer specification, a supplier specification, a process recipe, a chamber parameter, a pre-seasoning time, and a type of process used to manufacture the substrate.

8. The method for manufacturing a substrate with a plasma processing system as recited in claim 1, wherein the film of material is determined by at least one of a customer specification, a supplier specification, a process recipe, a chamber parameter, a pre-seasoning time, and type of process used to manufacture the substrate.

9. The method for manufacturing a substrate with a plasma processing system as recited in claim 1, wherein the film of material has a thickness within a range of about 1 to about 500 microns.

10. The method for manufacturing a substrate with a plasma processing system as recited in claim 1, wherein the film of material comprises a material selected from the group consisting of silicon dioxide, titanium nitride, FSG, fluorocarbon material, aluminum, materials related to said plasma, and materials related to a mask layer on said substrate.

11. The method for manufacturing a substrate with a plasma processing system as recited in claim 1, further comprising pumping excess gas through a pump opening arranged in the plasma processing chamber.

12. The method for manufacturing a substrate with a plasma processing system as recited in claim 11, wherein:
the obtaining includes obtaining a pumping deposition shield that has been coated with a film of material; and
the component disposing includes disposing said pumping deposition shield in the pump opening.

13. The method for manufacturing a substrate with a plasma processing system as recited in claim 1, wherein:
the obtaining includes obtaining a liner that has been coated with a film of material, and
the component disposing includes disposing said liner on an inner wall of the plasma processing chamber.

14. The method for manufacturing a substrate with a plasma processing system as recited in claim 1, further comprising optically detecting a plasma process condition through a diagnostic opening arranged in the plasma processing chamber.

15. The method for manufacturing a substrate with a plasma processing system as recited in claim 14, wherein:
the obtaining includes obtaining an optical window deposition shield that has been coated with a film of material; and
the component disposing includes disposing said optical window deposition shield in the diagnostic opening.

16. The method for manufacturing a substrate with a plasma processing system as recited in claim 11, wherein:
the obtaining includes obtaining a pumping baffle plate that has been coated with a film of material; and
the component disposing includes disposing the pumping baffle plate such that the pumping baffle plate separates the pump opening from the processing region, said pumping baffle plate extending from the inner wall of the process chamber to the periphery of the chuck and comprising a plurality of holes there through.

17. The method for manufacturing a substrate with a plasma processing system as recited in claim 16, wherein the pumping baffle plate has a shape selected from the group consisting of a cylindrical form, a polygonal form and an elliptical form.

18. The method for manufacturing a substrate with a plasma processing system as recited in claim 1, wherein:
the obtaining includes obtaining a plasma baffle assembly that has been coated with a film of material; and
the method further comprises attenuating the plasma within the plasma processing chamber in a space proximate to the substrate with the plasma baffle assembly.

19. The method for manufacturing a substrate with a plasma processing system as recited in claim 18, wherein the baffle assembly has a shape selected from the group consisting of a cylindrical form, a conical form, a polygonal form and a spherical form.

20. The method for manufacturing a substrate with a plasma processing system as recited in claim 18, wherein the plasma baffle assembly has holes through a wall of said plasma baffle assembly.

21. The method for manufacturing a substrate with a plasma processing system as recited in claim 1, further comprising:
moving the chuck to the plasma processing region with a moving assembly.

22. The method for manufacturing a substrate with a plasma processing system as recited in claim 21, wherein:
the obtaining includes obtaining a bellows shield that has been coated with a film of material; and
the component disposing includes disposing the bellows shield along the moving assembly and at a periphery of the chuck.

23. The method for manufacturing a substrate with a plasma processing system as recited in claim 1, wherein:
the obtaining includes obtaining a shield ring and a focus ring that have been coated with a film of material; and
the component disposing includes disposing the ring member and the focus ring on the chuck at a periphery of the substrate to control a plasma condition proximate to this periphery.

24. The method for manufacturing a substrate with a plasma processing system as recited in claim 1, wherein the plasma is formed by a plasma generating system that comprises an electrode disposed in the plasma processing chamber.

25. The method for manufacturing a substrate with a plasma processing system as recited in claim 24, wherein the obtaining includes obtaining the electrode that has been coated with a film of material.

26. The method for manufacturing a substrate with a plasma processing system as recited in claim 25, further comprising injecting process gas through a plurality of holes in the electrode.

27. The method for manufacturing a substrate with a plasma processing system as recited in claim 25, wherein the electrode is grounded.

28. The method for manufacturing a substrate with a plasma processing system as recited in claim 24, wherein:
the obtaining includes obtaining an insulating member that has been coated with a film of material; and
the component disposing includes disposing said insulating member between the electrode and an inner wall of the plasma processing chamber.

29. The method for manufacturing a substrate with a plasma processing system as recited in claim 24, wherein:
the obtaining includes obtaining an upper shield ring that has been coated with a film of material in the; and
the component disposing includes disposing said upper shield ring at a periphery of the electrode to control a plasma condition proximate to this periphery.

30. The method for manufacturing a substrate with a plasma processing system as recited in claim 1, wherein the forming includes forming the plasma with a plasma generating system that comprises an inject plate assembly for injecting process gas in the processing region and an electrostatic radio frequency source having a process tube housing a magnetic coil.

31. The method for manufacturing a substrate with a plasma processing system as recited in claim 30, wherein the obtaining includes obtaining the inject plate assembly and the process tube that has been coated with a film of material.
